(19) United States
(12) Patent Application Publication
(10) Pub. No.: US 2026/0004065 A1
(43) Pub. Date: Jan. 1, 2026

(54) SYSTEM AND METHOD FOR AUTOMATED ARABIC LANGUAGE QUALITY ASSURANCE, PERFORMANCE OPTIMIZATION, AND SECURITY ENHANCEMENT OF GOVERNMENT WEBSITES

(71) Applicant: Digital Government Authority, Riyadh (SA)

(72) Inventors: Khalid Saud Almuraee, Riyadh (SA); Moath Ali Alzahrani, Riyadh (SA); Abdulmohsen Ahmed AlMadhi, Riyadh (SA); Hanan Khalid Alsalamah, Riyadh (SA)

(73) Assignee: Digital Government Authority, Riyadh (SA)

(21) Appl. No.: 18/757,818

(22) Filed: Jun. 28, 2024

(51) Int. Cl. G06F 40/253; G06F 16/951; G06F 16/958; G06F 21/57

(52) U.S. Cl. CPC G06F 40/253; G06F 16/951; G06F 16/958; G06F 21/577

(57) ABSTRACT

The current invention relates to a novel system and method for comprehensively assessing and enhancing the quality of Arabic language content on government websites. The system utilizes artificial intelligence (AI), specifically deep learning models, to automatically detect and classify a wide range of errors in Arabic text, including spelling, grammatical, stylistic, and content-related errors. The system further generates statistical data on error frequency and types, facilitating data integrity analysis and identifying potential security risks. Additionally, the system incorporates integrated features for search engine optimization (SEO), performance monitoring, and security testing, thereby providing a holistic solution for improving government websites' overall functionality, usability, and security.

### FIELD

This specification relates to a system and method for Natural Language Processing (NLP), specifically for detecting and correcting errors in Arabic text and analyzing data integrity and security on government websites.

### BACKGROUND

Arabic, with its rich morphology, syntax, and semantics, presents unique challenges for automated error detection and correction. Existing solutions often lack comprehensive coverage of error types or fail to address the specific needs of government websites, such as compliance with national standards and accessibility requirements. Errors in linguistic accuracy can reduce credibility and confuse users, impacting communication and compliance. Moreover, website performance and security are critical aspects that demand continuous monitoring and optimization to ensure efficient service delivery and protect sensitive information. Weak security exposes government websites to data breaches, damaging trust and risking sensitive information, and impaired performance leads to bad experiences. Inadequate SEO diminishes the visibility of government services, leading to underutilization and reduced awareness. The present invention aims to overcome these limitations by providing a comprehensive, AI-powered platform for Arabic language quality assurance, performance optimization, security enhancement, and SEO improvement.

Currently, no platform performs an audit and checks on multiple metrics for a website. Some platforms measure specific metrics, such as SEO, but not all are in the same place. In addition, there is no platform to conduct Arabic language audits. The closest examples are Grammarly for English language review, Grammarly® is a registered trademark of Grammarly, Inc., and Lisan and Qalam for Arabic, Lisan™ is a trademark of Lisan Est. for AI, and Qalam™ is a trademark of Mawdoo3 Limited. Still, they can only be used in Word and text editors, not to crawl and audit the website's content.

### DESCRIPTION OF PRIOR ART

The closest prior art to the subject matter of this invention includes the following patent and non-patent documents:
(a) Patent Literature:
   D1. U.S. Patent Application Publication U.S. 2024/0012840A1: Discloses Arabic information extraction and semantic search but does not address the present invention's comprehensive quality assurance, performance optimization, and security enhancement aspects.
   D2. U.S.20190362098A1 describes a method for automatically detecting and correcting errors in Arabic texts, focusing on various types of errors, such as spelling and grammatical errors, using NLP techniques.
   D3. U.S.20200355931A1 encompasses methods for analyzing and correcting errors in multilingual web content, including Arabic, using machine learning models.
   D4. EP3373641A1 involves systems for detecting language errors and emphasizes statistical analysis and reporting errors, which correlates with generating statistical data and outputting reports.
(b) Non-Patent Literature:
   D5. “Deep Learning for Arabic Error Detection and Correction”: ACM Transactions on Asian and Low-Resource Language Information Processing Volume 19 Issue 5 Article No.: 71pp 1-13. The document explores deep learning models like Bi-directional Long Short-Term Memory (BiLSTM) networks for detecting and correcting Arabic spelling and grammatical errors. Still, it does not encompass the broader range of error types or website performance and security aspects the present invention covers.
   D6. “Advancements in Arabic Grammatical Error Detection and Correction: An Empirical Investigation”: By Bashar Alhafni, Go Inoue, Christian Khairallah, and Nizar Habash, arXiv:2305.14734v1 [cs.CL] 24 May 2023. The document investigates transformer-based models for Arabic grammatical error detection and correction. Still, it does not address the full scope of linguistic errors or website performance and security aspects the present invention covers.
   D7. “Improved Spelling Error Detection and Correction for Arabic”: Attia, Mohammed & Pecina, Pavel & Samih, Younes & Shaalan, Khaled & Genabith, Josef. (2012). The document focuses on improved methods for detecting and correcting spelling errors in Arabic but does not address the wider range of error types or website performance and security aspects addressed by the present invention.
   D8. “Challenges and Opportunities for Arabic Question-Answering Systems”: Alrayzah A, Alsolami F, Saleh M. 2023. Challenges and opportunities for Arabic question-answering systems: current techniques and future directions. PeerJ Computer Science 9: e1633 https://doi.org/10.7717/peerj-cs.1633. The document highlights the complexities of processing Arabic text due to its rich morphology and orthographic ambiguity, but it does not provide solutions for comprehensive quality assurance, performance optimization, or security enhancement of government websites.

### SUMMARY OF THE INVENTION

Arabic Natural Language Processing (ANLP) represents an increasingly significant area of research, particularly in the context of the Arabic language. This domain involves developing various techniques and tools specifically tailored to the nuances of Arabic. Numerous systems have been developed for applications such as machine translation, information retrieval and extraction, localization, and multilingual information retrieval systems. These applications face numerous complex challenges inherent to the structure and characteristics of the Arabic language.

Arabic Natural Language Processing (ANLP) is in high demand across various sectors. For instance, non-Arabic government institutions face challenges in correctly identifying Arabic names. ANLP tools that scan and recognize names, places, and dates are essential for saving time otherwise spent waiting for language experts. Current translation tools, such as Google Translate, Google Translate™ is a trademark of Google LLC., which translates English sentences into Arabic (or vice versa) by providing the meaning of each word without considering the context of the entire sentence.

Machine translation aims to translate sentences from one language, like Arabic, to provide the closest meaning in another language. ANLP applications manage text at the sentence level, identifying word order, grammar, and overall sentence meaning, which is particularly useful for machine translation tasks.

The system provides a system and method that leverages AI, specifically deep learning models, to automatically detect, classify, and potentially correct a wide array of errors in Arabic text found on government websites. The system categorizes errors into various types, including spelling, grammatical, stylistic, and content-related errors, aligning with national linguistic standards. The system also generates statistical data on error frequency and types, enabling data integrity analysis and the identification of potential security risks.

Furthermore, the system integrates features for SEO optimization, performance monitoring, and security testing. It includes tools for SEO audit, link health monitoring, and content relevance analysis to enhance website visibility and search engine rankings. The system also monitors page load speed, content load speed, broken links (404 errors), redirect pages, and server errors to ensure optimal website performance and user experience. In addition, the system offers automated security testing, including vulnerability scanning, penetration testing, injection testing, cross-site scripting (XSS) detection, session management testing, cross-site request forgery (CSRF) prevention, security misconfiguration analysis, sensitive data exposure testing, access control security checks, and evaluation of vulnerabilities and component dependencies.

The present invention distinguishes itself from the prior art by providing a holistic solution that addresses a broader range of Arabic language errors and integrates SEO optimization, performance monitoring, and security testing into a single AI-powered platform. This integrated approach enables government websites to improve the quality, accessibility, and security of their content while ensuring optimal performance and visibility to the public.

The present invention relates to natural language processing (NLP), web development, and cybersecurity. It addresses the challenges of maintaining high-quality Arabic content on government websites, optimizing website performance, ensuring robust security measures, and enhancing search engine optimization (SEO).

With its rich morphology, syntax, and semantics, Arabic presents unique challenges for automated error detection and correction. Existing solutions often lack comprehensive coverage of error types or fail to address the specific needs of government websites, such as compliance with national standards and accessibility requirements. Moreover, website performance and security are critical aspects that demand continuous monitoring and optimization to ensure efficient service delivery and protect sensitive information. The present invention aims to overcome these limitations by providing a comprehensive, AI-powered platform for Arabic language quality assurance, performance optimization, security enhancement, and SEO improvement.

The present invention provides a system and method that leverages AI, specifically deep learning models, to automatically detect, classify, and potentially correct a wide array of errors in Arabic text found on government websites. The system categorizes errors into various types, including spelling, grammatical, stylistic, and content-related errors, aligning with national linguistic standards. The system also generates statistical data on error frequency and types, enabling data integrity analysis and the identification of potential security risks.

Furthermore, the system integrates features for SEO optimization, performance monitoring, and security testing. The SEO optimization tools analyze website content for effectiveness, including keyword density, meta tags, and ALT attributes (Alternative attributes), and monitor link health and content relevance. Performance monitoring tracks page load speed, content load speed, and server errors to ensure optimal website performance. Security testing includes automated vulnerability scanning and penetration testing to identify and mitigate potential security risks.

### BRIEF DESCRIPTION OF THE DRAWINGS

FIG. 1: Block diagram illustrating the overall architecture of the system. The Frontend, Backend, Database, Web Crawlers, Analysis Service, Vector Database, and In-memory Database components and their interactions.

FIG. 2: Flow diagram showing the functional workflow of the system, starting from the input of a Web URL to the execution of various audits, including SEO Audit, Security Audit, Computer Vision Model analysis, Technical Audit, and Language Model evaluation.

FIG. 3: Screenshot illustrating the detection and categorization of language issues within website content, showing how errors are identified and presented for correction.

FIG. 4: Screenshot of the language and correction dashboard, which provides metrics on detected linguistic issues and their suggested corrections, and a detailed view of the language quality and error management.

FIG. 5: Screenshot showing details of broken links detected during the audit, including statistics on different types of HTTP response codes, helping identify and rectify non-functional links.

FIG. 6: Screenshot illustrating the performance metrics related to the website's page speed, showing key indicators like initial load time, largest contentful paint, and total blocking time.

FIG. 7: Executive dashboard screenshot, providing an aggregated overview of various audit results, including technical, security, SEO, and language audits, summarizing the website's overall performance and highlighting critical areas.

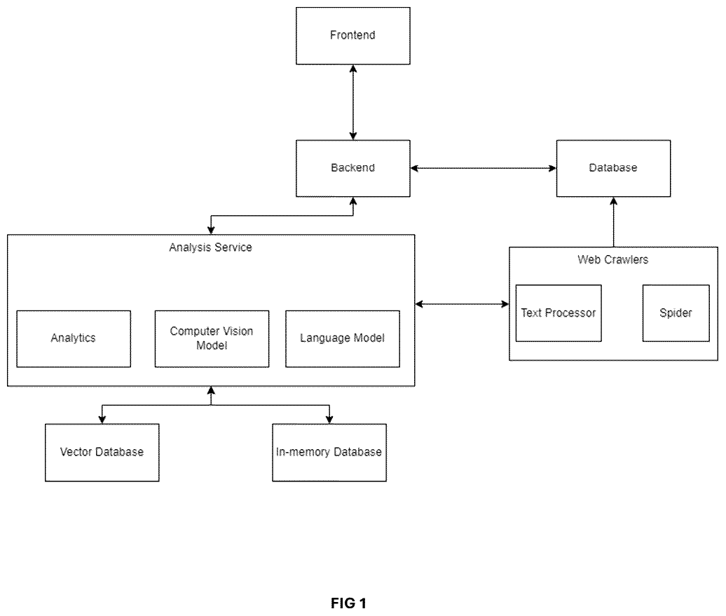

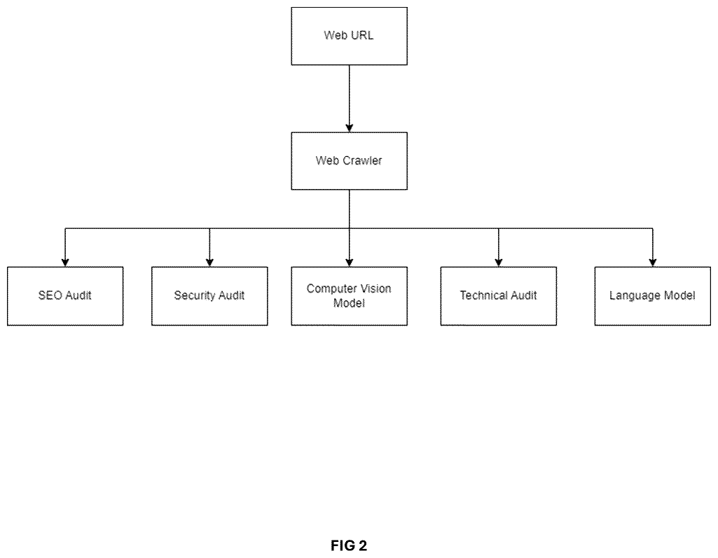

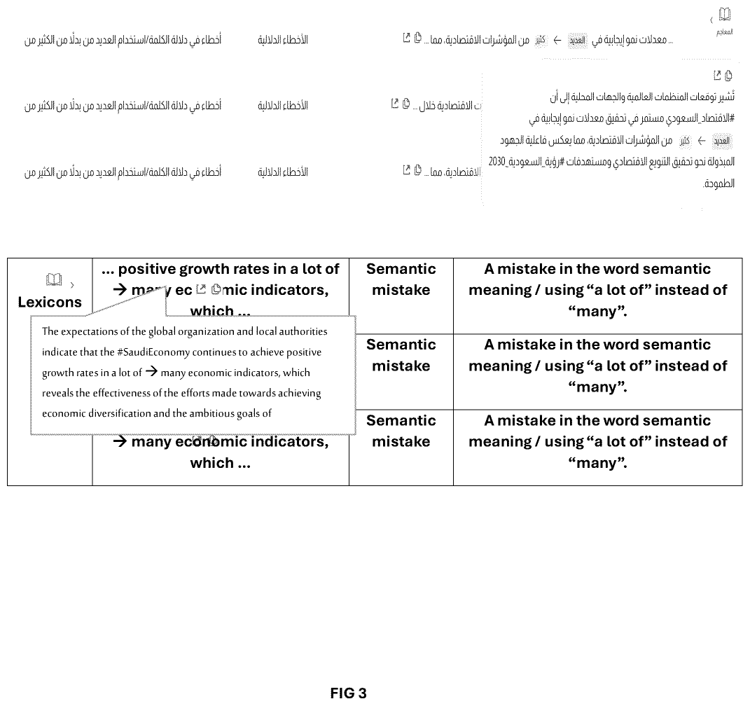

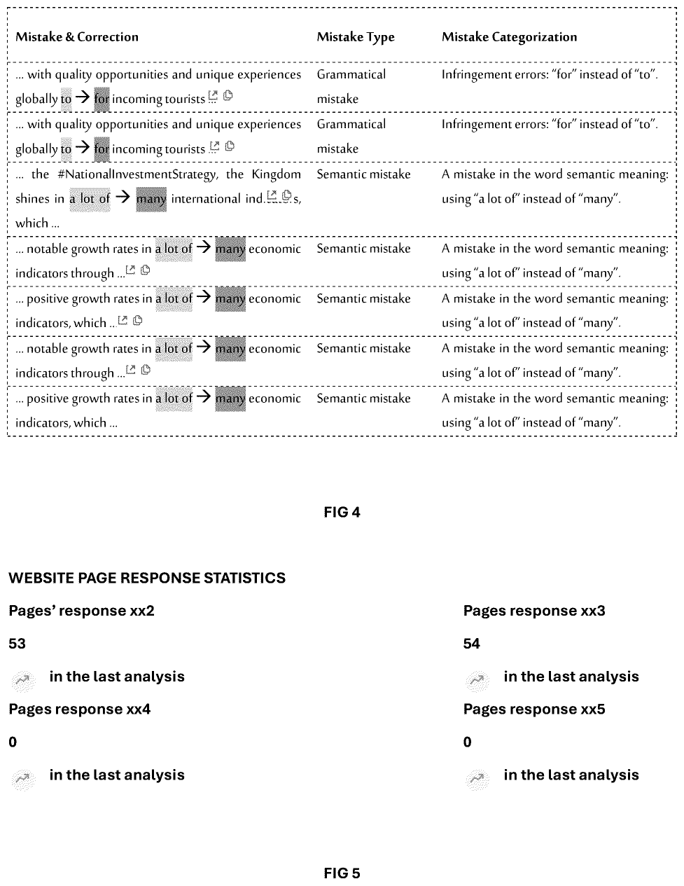

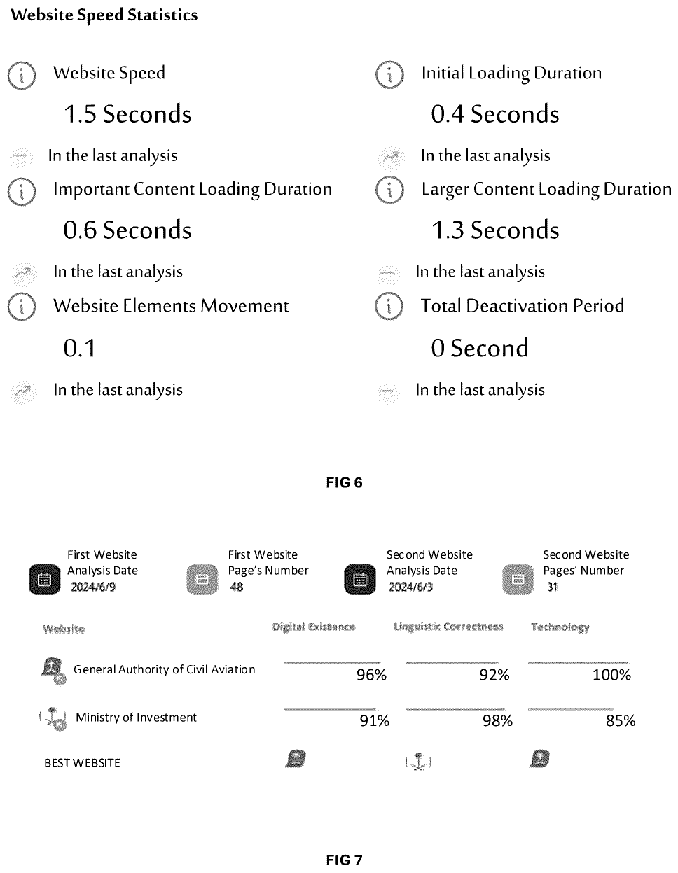

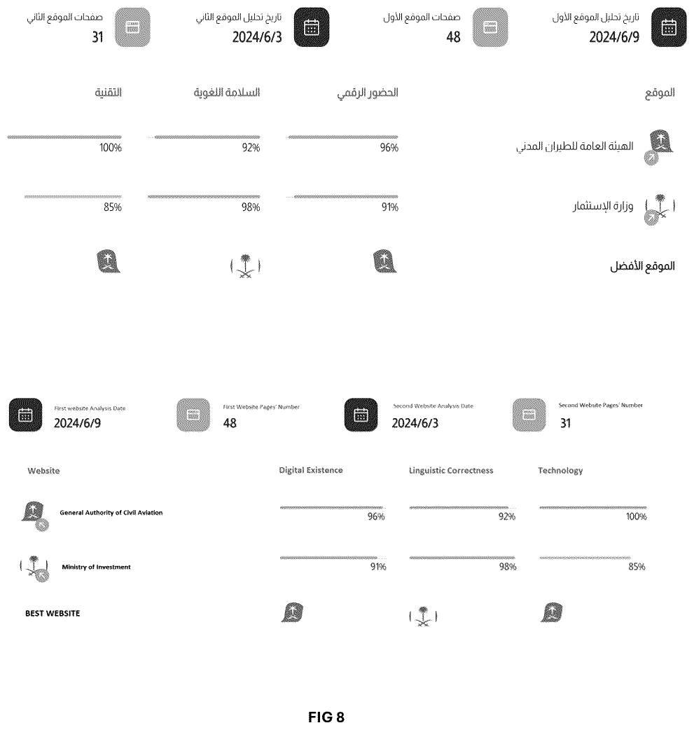

### DETAILED DESCRIPTION

The present invention comprises a system and method for assessing and enhancing the quality of Arabic language content on government websites. The system operates by first employing a web crawler to scan the target websites and collect Arabic text content systematically. The collected text is then preprocessed to remove irrelevant content and normalize formatting. The model has been trained on Arabic literature sourced from credible and authoritative references. It employs a Transformer architecture to evaluate and assess the syntax and grammar of the Arabic language. The Transformer model leverages multiple specialized attention heads, each focusing on different aspects of Arabic syntax, grammar, semantics, styles, and linguistic nuances. This approach ensures comprehensive analysis and accurate assessments, enhancing the model's ability to handle complex linguistic structures and variations present in Arabic literature. Additionally, the model is designed to support various dialects and stylistic forms. The Transformer Model, which is specifically designed for sequence transduction tasks and involves converting one sequence of tokens, such as words, into another sequence. The Transformer Model utilizes attention mechanisms, particularly self-attention, to process inputs and generate outputs in an efficient and effective manner. Very much as described in U.S. Pat. No. 10,452,978.

The preprocessed text is subsequently fed into an AI model, specifically a deep learning model trained on a large corpus of correct Arabic usage and national linguistic standards. The AI model analyzes the text, identifying and classifying errors into various types: spelling, grammatical, stylistic, and content-related. The model's ability to detect and classify errors is based on its training on a vast dataset of correct Arabic usage, enabling it to recognize patterns and deviations from standard language norms.

In addition to error detection and classification, the system generates comprehensive statistical data on the frequency and types of detected errors. This data is then analyzed to assess the integrity of the data and the website's security risks. For instance, inconsistencies in names, dates, or numerical figures could indicate data integrity issues, while certain patterns of language use might suggest potential phishing attempts or other security threats.

The system further incorporates integrated features for SEO optimization, performance monitoring, and security testing. The SEO optimization tools analyze website content for effectiveness, including keyword density, meta tags, and ALT attributes, and monitor link health and content relevance. Performance monitoring tracks page load speed, content load speed, and server errors to ensure optimal website performance. Security testing includes automated vulnerability scanning and penetration testing to identify and mitigate potential security risks.

The system's output is a comprehensive report that details the detected errors, their types, locations, and the statistical data generated. This report serves as a valuable tool for website administrators and content creators to identify areas for improvement and take corrective actions. The system may also be configured to suggest corrections for the detected errors, further aiding in enhancing website content quality.

The present invention comprises a system and method for assessing and enhancing the quality of Arabic language content on government websites. The system operates by first employing a web crawler to scan the target websites and collect Arabic text content systematically. The collected text is then preprocessed to remove irrelevant content and normalize formatting.

The preprocessed text is subsequently fed into an AI model, specifically a deep learning model trained on a large corpus of correct Arabic usage and national linguistic standards. The AI model analyzes the text, identifying and classifying errors into various types: spelling, grammatical, stylistic, and content-related. The model's ability to detect and classify errors is based on its training on a vast dataset of correct Arabic usage, enabling it to recognize patterns and deviations from standard language norms. In addition, the system enables the detection of linguistic errors such as spelling, grammatical, semantic, stylistic, title, and punctuation errors.

In addition to error detection and classification, the system generates comprehensive statistical data on the frequency and types of detected errors. This data is then analyzed to assess the integrity of the data and the website's security risks. For instance, inconsistencies in names, dates, or numerical figures could indicate data integrity issues, while certain patterns of language use might suggest potential phishing attempts or other security threats.

The system further incorporates integrated features for SEO optimization, performance monitoring, and security testing. The SEO optimization tools analyze website content for effectiveness, including keyword density, meta tags, and ALT attributes, and monitor link health and content relevance. Performance monitoring tracks page load speed, content load speed, and server errors to ensure optimal website performance. The system can detect technical issues that jeopardize performance reliability through detecting different technical aspects such as Initial Load Duration, Overall Site Speed, Content Load Duration, Largest Content Load Duration, Total Disruption Time, and Movement of Site Elements. Security testing includes automated vulnerability scanning and penetration testing to identify and mitigate potential security risks. The system also includes automated reports, injection testing, cross-site scripting (XSS), session management testing, cross-site request forgery (CSRF), security misconfiguration analysis, sensitive data exposure testing, access control security checks, vulnerabilities, and component dependency evaluation.

### Preferred Embodiments

In a preferred embodiment, the AI model used in The system is a deep learning model, such as a Recurrent Neural Network (RNN) or Transformer, trained on a large dataset of Arabic text. The model is trained using supervised learning techniques, where it learns to identify and classify errors by comparing the input text with the correct usage patterns in the training data. Based on its learned language model, it may also be configured to suggest corrections for the detected errors.

In another preferred embodiment, the system includes a user interface that allows users to interact with the system, view reports, and configure settings. The user interface may also provide visualizations of the statistical data, such as graphs and charts, to facilitate data analysis and interpretation.

To illustrate how the system can be applied to specific Saudi government websites, the system provides real examples based on the current content of these websites. These examples show how the system can enhance content accuracy, language quality, and security.

### 1. Saudi Ministry of Interior (MOI)

### Example: News Section

Current Content Example: An announcement on the MOI website reads: “The Ministry of Interior launched a new service for electronically renewing passports. Service is available for citizens and expatriates.”

### Implementation:

i. Web Crawler and Preprocessing:
   a. The web crawler collects this announcement along with other announcements similar to those from the MOI website.
ii. AI Model Analysis:
   a. Spelling and Grammar Check: The AI model detects any spelling errors or grammatical mistakes.
   b. Stylistic Analysis: Ensures the announcement follows formal Arabic standards. For instance, it checks for correct verb forms and proper noun usage.
iii. Example Correction:
   a. If the announcement initially had a typo, such as “electronically” misspelled as “elictronically,” the system would flag and correct it.
iv. Security and Integrity Assessment:
   a. Inconsistencies Check: Ensures the consistency of terms like “Passports” across the website. If other website sections use different terms for the same concept, the system flags it.
   b. Potential Threats: Patterns suggesting unusual language use, which might indicate phishing attempts, are flagged.
v. SEO Optimization and Performance Monitoring:
   a. Keyword Density: Ensures the announcement contains relevant keywords for better search engine ranking.
   b. Performance Metrics: Checks if the page loads quickly and efficiently.
vi. Security Testing:
   a. Vulnerability Scanning: Ensures there are no script injections or other vulnerabilities on the announcement page.
vii. Reporting and Corrections:
   Detailed Report: Provides a report with detected errors, suggested corrections, and performance metrics.

### 2. Saudi Food and Drug Authority (SFDA)

### Example: Product Regulation

Current Content Example: A regulation on the SFDA website reads:
“All importers must submit complete documents about foodstuffs.”

### Implementation:

i. Web Crawler and Preprocessing:
   a. The web crawler collects this regulation text along with other regulations from the SFDA website.
ii. AI Model Analysis:
   a. Spelling and Grammar Check: Detects errors in document submission guidelines.
   b. Stylistic Analysis: Ensures formal and technical language is used correctly.
iii. Example Correction:
   a. If the regulation has a grammatical error, such as “Importers” instead of the correct “Importirs,” the system flags and corrects it.
iv. Security and Integrity Assessment:
   a. Inconsistencies Check: Ensures consistent terminology usage, such as “Food Products” across different documents.
   b. Potential Threats: Detects unusual language patterns that could indicate phishing.
v. SEO Optimization and Performance Monitoring:
   a. Keyword Density: Optimizes the text for search engines by analyzing keyword density.
   b. Performance Metrics: Ensures the regulation page loads quickly.
vi. Security Testing:
   a. Vulnerability Scanning: Checks for security vulnerabilities on the regulation page.
vii. Reporting and Corrections:
   a. Detailed Report: Includes detected errors, suggested corrections, and performance metrics.

### 3. Saudi Arabian Monetary Authority (SAMA)

### Example: Financial Report

Current Content Example: A financial report on the SAMA website reads:
“In the first quarter of this year, economic growth percentage reached 3.2%.”

### Implementation:

i. Web Crawler and Preprocessing:
   a. The web crawler collects this financial report and other reports from the SAMA website.
ii. AI Model Analysis:
   a. Spelling and Grammar Check: Detects errors in numerical and date formats.
   b. Stylistic Analysis: Ensures formal financial language is used correctly.
iii. Example Correction:
   a. If the report had a typo in the percentage, such as “3.2%” miswritten, the system flags and corrects it.
iv. Security and Integrity Assessment:
   a. Inconsistencies Check: Ensures consistency in financial terms and figures.
   b. Potential Threats: Detects language patterns that could indicate security threats.
v. SEO Optimization and Performance Monitoring:
   a. Keyword Density: Optimizes the report for search engines by analyzing keyword density.
   b. Performance Metrics: Ensures the report page loads efficiently.
vi. Security Testing:
   a. Vulnerability Scanning: Checks for security vulnerabilities on the report page.
vii. Reporting and Corrections:
   a. Detailed Report: Provides a report with detected errors, suggested corrections, and performance metrics.

These real examples from Saudi government websites illustrate how the system can be implemented to enhance content accuracy, language quality, and security. Using the web crawler, AI model analysis, and various optimization tools ensures that government websites provide high-quality, accurate, and secure Arabic content.

In another preferred embodiment, the system includes a user interface that allows users to interact with the system, view reports, and configure settings. The user interface may also provide visualizations of the statistical data, such as graphs and charts, to facilitate data analysis and interpretation

Here is an illustration of the preferred embodiment with a user interface that allows users to interact with the system, view reports, and configure settings using real examples from Saudi government websites. The interface also provides visualizations of statistical data to facilitate analysis and interpretation.

### 1. Saudi Ministry of Interior (MOI)—User Interface Example

### Example: Interactive Dashboard for Announcements

Current Content Example: The Ministry of Interior (MOI) website frequently updates its announcements section with new services and public notices.

### User Interface Implementation:

i. Dashboard Overview:
   a. Announcements Statistics: The dashboard displays a graph showing the number of announcements posted each month.
   b. Error Types and Frequency: A pie chart categorizes common errors detected in announcements, such as spelling mistakes, grammatical errors, and stylistic inconsistencies.
ii. Interacting with Reports:
   a. Detailed Reports: Users can click on any section of the pie chart to view detailed reports on the types of errors, their locations, and suggested corrections.
   b. Announcements History: A line chart tracks the historical accuracy of announcements over time, showing improvements after corrections.
iii. Configuring Settings:
   a. Error Sensitivity: Users can adjust settings to change the sensitivity of the error detection model, making it more or less stringent.
   b. Notification Preferences: Users can configure the system to send alerts when new errors are detected or when specific types of errors exceed a threshold.
iv. Visualization Example:
   Graphs and Charts: The interface shows a bar graph comparing the frequency of different types of errors over the past six months.

### 2. Saudi Food and Drug Authority (SFDA)—User Interface Example

### Example: Interactive Dashboard for Product Regulations

Current Content Example: The SFDA website includes extensive regulations on product safety, standards, and compliance requirements.

### User Interface Implementation:

i. Dashboard Overview:
   a. Regulations Statistics: A bar graph displays the number of new regulations published each quarter.
   b. Error Analysis: A stacked bar chart shows the breakdown of detected errors in each category of regulations.
ii. Interacting with Reports:
   a. Detailed Reports: Clicking on a bar in the graph provides a detailed report of the specific errors found in a particular regulation, along with recommended corrections.
   b. Trend Analysis: A line chart shows the trend of error reduction over time as corrections are implemented.
iii. Configuring Settings:
   a. Regulation Categories: Users can filter reports and error detection based on specific categories of regulations, such as food safety or pharmaceutical standards.
   b. Threshold Settings: Users can set thresholds for acceptable error rates, triggering alerts when exceeded.
iv. Visualization Example:
v. Graphs and Charts: The interface features a pie chart showing the proportion of spelling, grammatical, and technical errors in the last batch of regulations analyzed.

### 3. Saudi Arabian Monetary Authority (SAMA)—User Interface Example

### Example: Interactive Dashboard for Financial Reports

Current Content Example: SAMA publishes regular financial reports and economic analyses on its website.

### User Interface Implementation:

i. Dashboard Overview:
   a. Financial Reports Statistics: A line graph tracks the publication frequency of financial reports.
   b. Error Types and Frequency: A heat map visualizes the common errors across different sections of financial reports, such as numerical inconsistencies and terminology errors.
ii. Interacting with Reports:
   a. Detailed Reports: Clicking on a section of the heat map opens a detailed report on detected errors, highlighting specific areas with high error rates.
   b. Historical Data: Users can view historical data on error detection, comparing past and present reports to measure improvements.
iii. Configuring Settings:
   a. Error Categories: Users can configure the system to focus on specific error categories, such as financial terminologies or numerical data.
   b. Custom Alerts: Users can set custom alerts for critical errors, ensuring prompt attention to significant issues.
iv. Visualization Example:
v. Graphs and Charts: The interface provides a scatter plot showing the correlation between the length of financial reports and the number of detected errors, helping identify patterns.

By implementing an interactive user interface with detailed reports, configuration settings, and visualizations of statistical data, Saudi government agencies like the Ministry of Interior, Saudi Food and Drug Authority, and Saudi Arabian Monetary Authority can significantly enhance the quality and security of their Arabic content. These examples show how users can engage with the system to monitor content accuracy, analyze data, and make informed decisions to improve their websites.

1. A method for assessing and enhancing the quality of Arabic language content on a website, the method comprising:
i. Actively scanning the website to collect Arabic language text;
ii. Preprocessing the collected text to normalize formatting and remove irrelevant content;
iii. Processing the preprocessed text using a deep learning model trained on a corpus of correct Arabic usage to detect errors in the text, wherein the errors relate to at least one of spelling, contextual, grammatical, morphological, semantic, stylistic, linguistic politeness, separation and merging, punctuation, names, and quotations,
iv. Generating statistical data on the frequency and types of detected errors,
v. Analyzing the statistical data to assess at least one of the data integrity and security risks of the website and
vi. Outputting a report comprising at least the detected errors, their locations in the text, and the generated statistical data.

2. The method of claim 1, wherein preprocessing the collected text further comprises:
i. Segmenting the text into analyzable units, and
ii. Normalizing diacritics and orthographic variations specific to the Arabic language.

3. The method of claim 1 further comprising optimizing the website for search engine results based on an analysis of the collected text, including keyword density, meta tags, and ALT attributes.

4. The method of claim 1, further comprising monitoring the performance of the website by analyzing metrics such as page load speed, content load speed, and server errors.

5. The method of claim 1, further comprising testing the security of the website through automated vulnerability scanning and penetration testing based on an analysis of the collected text.

6. The method of claim 1, wherein the deep learning model is a Transformer model trained on a large dataset of Arabic text, capable of suggesting corrections for the detected errors.

7. The method of claim 1, wherein the statistical data generated is utilized to create visual representations such as graphs and charts for easier interpretation and analysis.

8. A system for assessing and enhancing the quality of Arabic language content on a website, the system comprising:
i. A web crawler configured to scan and collect Arabic text from the website;
ii. A preprocessing module to normalize and clean the collected text;
iii. A deep learning model for detecting and classifying errors in the text, trained on a corpus of correct Arabic usage;
iv. A statistical analysis module to generate data on error frequency and types;
v. An assessment module to analyze data integrity and security risks based on the statistical data and
vi. A reporting module to output a report detailing the detected errors, their locations, and the statistical data.

9. The system of claim 8 further comprising a user interface for displaying the report, configuring system settings, and visualizing statistical data.

10. The system of claim 8, further comprising tools for search engine optimization, including keyword density analysis, meta tag evaluation, and link health monitoring.

11. The system of claim 8, further comprising a performance monitoring module to track metrics such as page load speed, content load speed, and server errors.

12. The system of claim 8, further comprising a security testing module for automated vulnerability scanning and penetration testing.

13. The system of claim 8, wherein the reporting module provides actionable recommendations for improving the quality, performance, and security of the website.

14. A non-transitory computer-readable medium storing instructions that, when executed by a processor, cause a computer to perform the method of claim 1.
